(19) United States
(12) Patent Application Publication
(10) Pub. No.: US 2019/0001994 A1
(43) Pub. Date: Jan. 3, 2019

(54) VEHICLE CONTROL APPARATUS

(71) Applicant: DENSO CORPORATION, Kariya-city, Aichi-pref. (JP)

(72) Inventors: Kazuyoshi ISAJI, Kariya-city, Aichi-pref. (JP); Akihiko YAGYU, Kariya-city, Aichi-pref. (JP); Hiroaki TANAKA, Kariya-city, Aichi-pref. (JP); Ifushi SHIMONOMOTO, Kariya-city, Aichi-pref. (JP); Sei IGUCHI, Kariya-city, Aichi-pref. (JP); Toshiyuki ITO, Kariya-city, Aichi-pref. (JP); Yuji HIRABAYASHI, Tokyo (JP)

(73) Assignee: Denso Corporation, Kariya-city, Aichi-pref. (JO)

(21) Appl. No.: 16/064,848

(22) PCT Filed: Dec. 21, 2016
(86) PCT No.: PCT/JP2016/088195

§ 371 Date: Jun. 21, 2018

(30) Foreign Application Priority Data
Dec. 25, 2015 (JP) 2015-253327
Nov. 10, 2016 (JP) 2016-219660

(51) Int. Cl. B60W 50/14; G05D 1/00; B60W 30/02

(52) U.S. Cl. CPC B60W 50/14; B60T 7/12; B60W 30/025; G05D 1/0061

(57) ABSTRACT

In a vehicle control apparatus which controls movement of the own vehicle, the control unit obtains data of surroundings of the own vehicle. Then, according to the data of the surroundings, the control unit conducts vehicle control including acceleration/deceleration control representing control related to acceleration/deceleration of the own vehicle, and steering control representing control related to steering of the own vehicle. Upon input of a stop command indicating stop of the vehicle control, a first stop section stops first control which is either of the acceleration/deceleration control and the steering control. Then, a second stop section stops a second control, which is the other of the acceleration/deceleration control and the steering control, at a timing different from the timing to stop the first control (S310).

### CROSS-REFERENCE TO RELATED APPLICATIONS

The present international application claims the benefit of priorities from earlier Japanese Patent Application Nos. 2015-253327 and 2016-219660 filed in Japan Patent Office on Dec. 25, 2015 and Nov. 10, 2016, respectively, all the descriptions of which are incorporated herein by reference.

### TECHNICAL FIELD

The present disclosure relates to a vehicle control apparatus for controlling movement of the own vehicle.

### BACKGROUND ART

Such vehicle control apparatuses as mentioned above are widely known as representing a technology of preforming automatic driving of the own vehicle. According to the technology disclosed in PTL1, automatic driving is switched to manual driving instantly.

### CITATION LIST

### Patent Literature

[PTL 1] JP 2007-196809 A

### SUMMARY OF THE INVENTION

As a result of a detailed investigation conducted by the inventors, it has been found that drivers in general require some time to regain a sense of driving a vehicle when the driving mode is switched from automatic to manual, and therefore, if the mode is switched from automatic to manual suddenly, the driver would have difficulty in operating the own vehicle smoothly immediately after the mode change.

In one aspect of the present disclosure, it would be desirable that the driver is able to operate the own vehicle smoothly when the driving mode is switched from automatic to manual in a vehicle control apparatus which controls the movement of the own vehicle.

In a vehicle control apparatus according to one aspect of the present disclosure, a vehicle control unit is configured to obtain data of surroundings of an own vehicle and execute vehicle control including acceleration/deceleration control representing control for acceleration/deceleration of the own vehicle, and steering control representing control for steering of the own vehicle, according to the data of the surroundings. A first stop section is configured to stop a first control representing either of acceleration/deceleration control and steering control, upon input of a stop command representing command for stopping of vehicle control. A second stop section is configured to stop a second control representing the other of acceleration/deceleration control and steering control, at timing different from timing to stop the first control.

Such a vehicle control apparatus configured as set forth above stops operation of acceleration/deceleration control and steering control at different timing. Thus, the driver only needs to respond to the stop of acceleration/deceleration control and the stop of steering control in turn. Therefore, the driver can drive the own vehicle smoothly.

Each configuration may be combined optionally.

### BRIEF DESCRIPTION OF THE DRAWINGS

FIG. 1 is a block diagram illustrating a configuration of a vehicle control apparatus.

FIG. 2A is a flowchart (1/2) illustrating a manual-switching process executed by a control unit, according to a first embodiment.

FIG. 2B is a flowchart (2/2) illustrating the manual-switching process that the control unit executes, according to the first embodiment.

FIG. 3 is a diagram depicting a display image example when acceleration/deceleration control and steering control are automatic.

FIG. 4 is an illustration depicting a display example when acceleration/deceleration control is automatic and steering control is manual.

FIG. 5 is an illustration depicting a display example when steering assist is executed.

FIG. 6 is an illustration depicting a display example when acceleration/deceleration control and steering control are manual.

FIG. 7A is a flowchart (1/2) illustrating a manual-switching process that a control unit executes, according to a second embodiment.

FIG. 7B is a flowchart (2/2) illustrating a manual-switching process that the control unit executes, according to the second embodiment.

### DESCRIPTION OF THE EMBODIMENTS

With reference to the drawings, some embodiments of the present disclosure will be described.

### 1. First Embodiment

### 1-1. Configuration

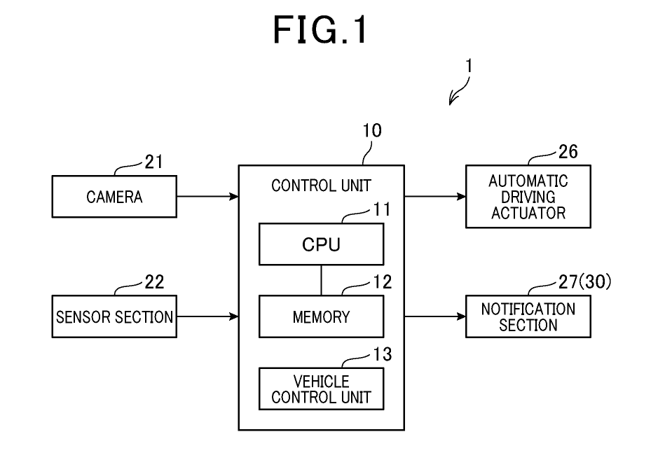

FIG. 1 shows a vehicle control apparatus 1 which is mounted on a vehicle such as a passenger vehicle, and performs automatic driving for the vehicle. In particular, the vehicle control apparatus 1 of the present embodiment performs vehicle control which includes acceleration/deceleration control related to acceleration/deceleration of the own vehicle, and steering control related to steering of the own vehicle. The vehicle control apparatus 1 has a function of switching the vehicle control to manual mode at different timing. The own vehicle herein refers to a vehicle equipped with the vehicle control apparatus 1.

As shown in FIG. 1, the vehicle control apparatus 1 includes a control unit 10, a camera 21, a sensor section 22, an automatic driving actuator 26, and a notification section 27. The camera 21 is a known camera that captures an image of the surroundings of the own vehicle including an area ahead of the own vehicle. The camera 21 is used for processing the captured image to recognize the surroundings of the own vehicle. The function of processing the captured image may be provided to the camera 21 or may be provided to the control unit 10.

The surroundings of the own vehicle herein refer to a group of the positions of a plurality of objects surrounding the own vehicle. This information is necessary for automatic driving of the own vehicle. More specifically, the surroundings of the own vehicle include the obstacles which may prevent traveling of the own vehicle, and regions on a road where the own vehicle can travel. The presence and the position of obstacles and regions are recognized by the vehicle control apparatus 1.

The sensor section 22 refers to a plurality of sensors mounted to the own vehicle. The sensor section 22 includes known sensors necessary for automatic driving of the own vehicle, such as a vehicle speed sensor, a yaw rate sensor, a steering angle sensor, a steering sensor, an accelerator opening sensor, and a brake pedal sensor. The detection results of the sensor section 22 are sent to the control unit 10.

The vehicle speed sensor detects the speed of the own vehicle. The yaw rate sensor detects the turning angular velocity of the own vehicle. The steering angle sensor detects the steering angle of a steered wheel. The steering sensor detects the angle of operation of the steering wheel.

The accelerator opening sensor detects an operation amount of an accelerator pedal. The brake pedal sensor detects an operation amount of a brake pedal. The operation amount herein refers to an amount of displacement of an operated part such as a pedal, or a magnitude of force of operation.

The automatic driving actuator 26 is configured to actuate the vehicle according to various control variables including an accelerator control variable, a brake control variable, and a steering control variable, determined by the control unit 10. The actuator 26 includes a motive power device which permits an engine, a motor or the like to generate motive power according to the accelerator control variable, a braking device which increases and decreases brake oil pressure according to the brake control variable, and a steering device which changes the steering angle according to the steering control variable.

The notification section 27 notifies the states of the acceleration/deceleration control or the steering control by using voice, images, lamps, and the like according to the command from the control unit 10. In particular, the present embodiment includes a mode of notifying the operation states in the form of image by using a headup display 30. This notification mode will be described later.

The control unit 10 is mainly comprised of a known microcomputer having a CPU 11 and a memory 12. The memory 12 is a semiconductor memory such as RAM, ROM, or a flash memory. Various functions of the control unit 10 are achieved by the CPU 11 executing a program stored in a non-transitory tangible recording medium. In the present example, the memory 12 corresponds to the non-transitory tangible recording medium which stores the program. By executing the program, processes corresponding to the program are executed. The control unit 10 may be comprised of one or more microcomputers.

The control unit 10 includes a function of automatically driving the own vehicle, and a function of notifying the state of the automatic driving function. These functions are accomplished by the CPU 11 executing the program. The automatic driving function includes a function as the vehicle control unit 13. The vehicle control unit 13 has functions to recognize the surroundings of the own vehicle from the image captured by the camera 21, to determine a trajectory for the actual traveling of the own vehicle according to the recognition resulting from the captured image, a predetermined destination, and the route to the destination, and to control the own vehicle along the trajectory. In this case, the control unit 10 determines the accelerator control variable, the brake control variable, and the steering control variable considering, for example, the positions or the speeds of the surrounding vehicles, or the positions or the moving speeds of other obstacles.

Although the control unit 10 accomplishes these functions using software, a part or all the functions may be accomplished by using hardware that is a combination such as of a logical circuit and an analog circuit.

### 1-2. Processing

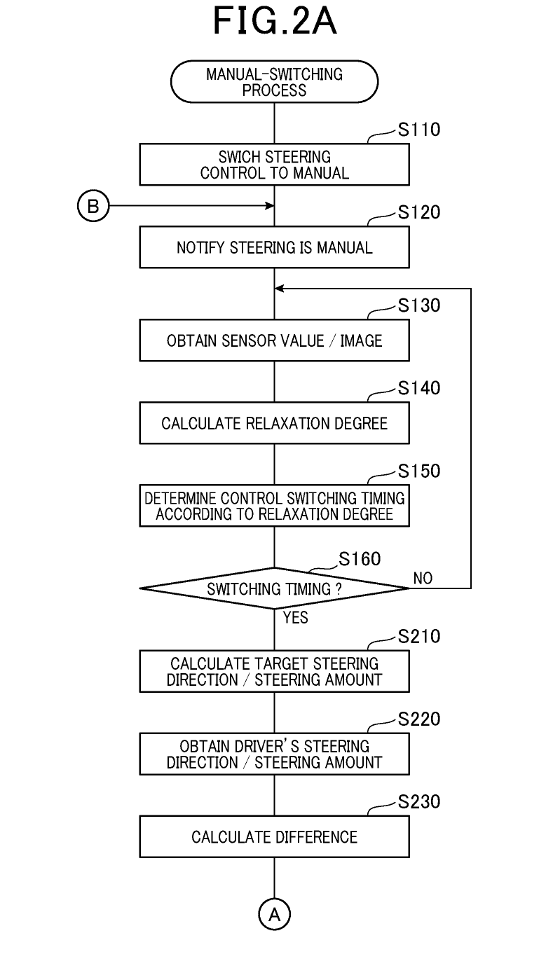

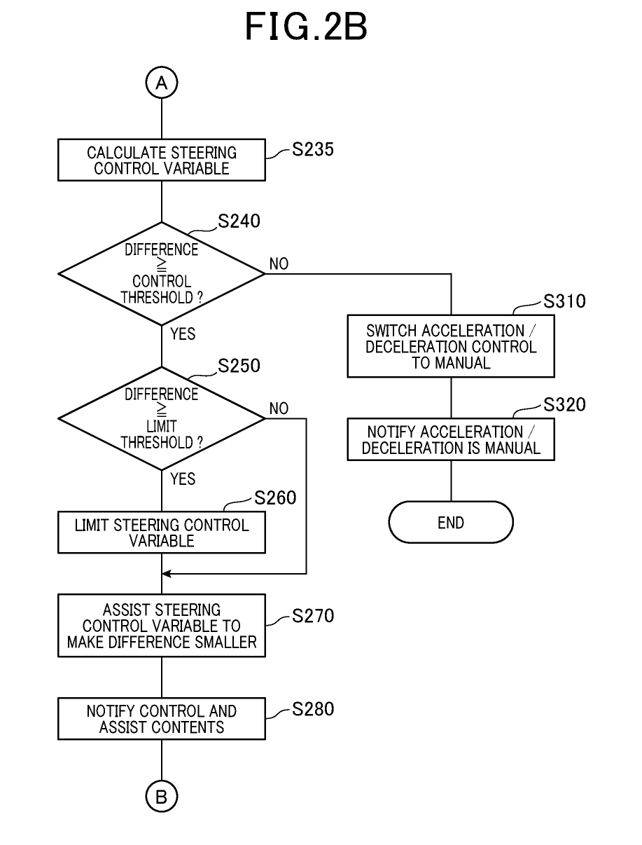

With reference to the flowchart shown in FIGS. 2A and 2B, a manual-switching process executed by the control unit 10 will be described. In the manual-switching process, vehicle control for automatic driving is stopped, and then manual driving is started when a stop command for switchover to the manual driving is inputted.

As shown in FIGS. 2A and 2B, in the manual-switching process, the control unit 10 stops steering control and switches the operation to manual at step S110. When steering control is switched to manual, the control unit 10 stops the operation of outputting the steering control variable for steering control to the automatic driving actuator 26. The control unit 10 then notifies the driver at step S120 that the steering control has been switched to manual.

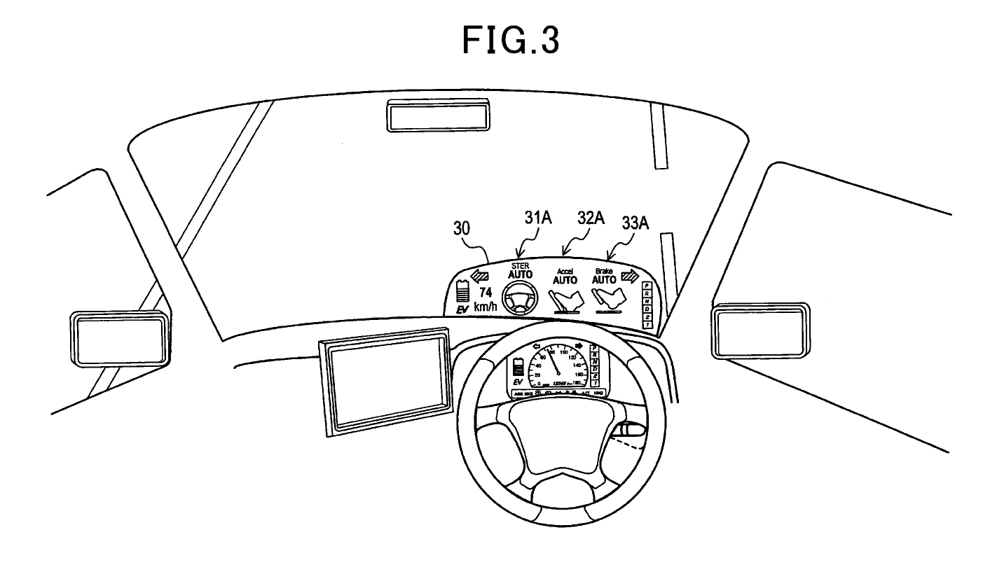

As shown in FIG. 3, while the control unit 10 executes steering control, the control unit 10 displays an automatic steering icon 31A, an automatic acceleration icon 32A, and an automatic braking icon 33A on the headup display 30. The automatic steering icon 31A includes a pattern representing a steering wheel, and information that the control unit 10 is actuated, that is, a literal sign “AUTO” indicating that the steering operation is automatic.

The automatic acceleration icon 32A includes a pattern representing an accelerator pedal, and a literal sign “AUTO” indicating that the accelerator operation is automatic. The automatic braking icon 33A includes a pattern representing a brake pedal, and a literal sign “AUTO” indicating that the brake operation is automatic.

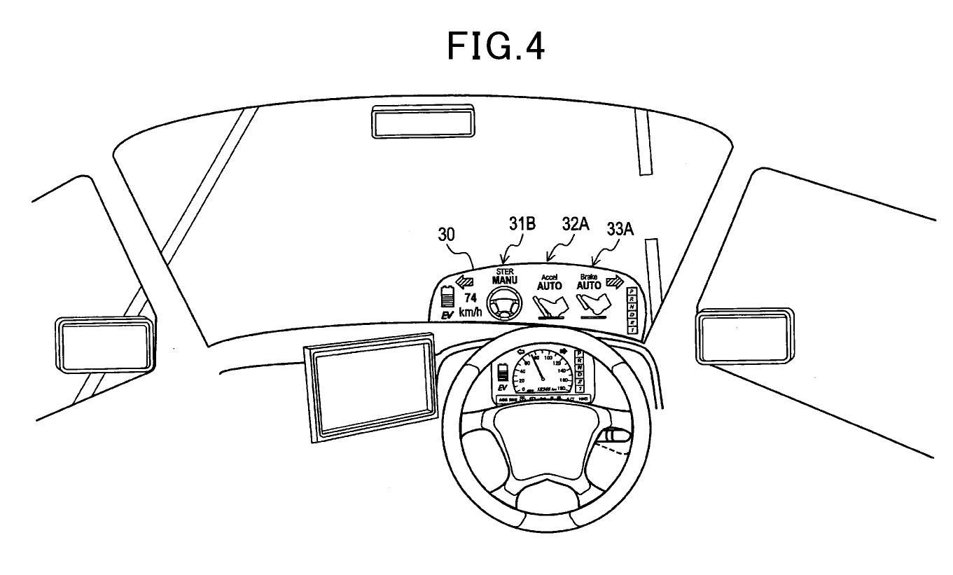

Then, as shown in FIG. 4, when the steering control is switched to manual, the control unit 10 displays a manual steering icon 31B on the headup display 30, instead of the automatic steering icon 31A. The control unit 10 permits the indication of the automatic acceleration icon 32A and the automatic braking icon 33A to remain unchanged.

The manual steering icon 31B includes a pattern representing a steering wheel, and information that the control unit 10 is not actuated, that is, a literal sign “MANU” indicating that the manual steering is in operation. “The control unit 10 is not actuated” refers to a situation that the function of the control unit 10, that is, the function of the steering control is not activated.

The display mode of the pattern indicating the steering wheel is different between the manual steering icon 31B and the automatic steering icon 31A. For example, the color or brightness is different. This allows the driver to distinguish automatic from manual at a glance. The driver here refers to a person who drives the own vehicle.

The control unit 10 then obtains the positions of objects at step S130 based on the image captured by the camera 21 and a sensor value obtained from the sensor section 22. The control unit 10, when it obtains the captured image from the camera 21, processes the image to recognize the positions and the types of the objects around the own vehicle. When processing the image, the control unit 10 uses known techniques such as pattern matching or white line recognition.

The control unit 10 then calculates a relaxation degree at step S140. The relaxation degree refers to smallness of the driver's driving load. The relaxation degree is large when the driver's driving load is small. The control unit 10 calculates the relaxation degree so as to be smaller when the own vehicle is cornering or when it is running on a slope road, or when the distance to an intersection, a merging point, or a branch point, where acceleration/deceleration or steering is required, is less than a reference distance. More specifically, the relaxation degree is determined to be smaller as the curvature radius of the road the own vehicle is running becomes smaller, or as the slope becomes larger, or as the distance to the intersection, the merging point, or the branch point becomes smaller.

The control unit 10 then determines the switching timing of acceleration/deceleration control at step S150 according to the determined relaxation degree. As the relaxation degree becomes smaller, that is, as the driver becomes less relaxed, the switching timing is determined to be later. For example, if the relaxation degree is sufficiently large, that is, if the driver's driving load is small, the control unit 10 determines the switching timing to arrive about five seconds after the steering control is switched to manual. If the relaxation degree is sufficiently small, that is, if the driver's driving load is large, the control unit 10 determines the switching timing to arrive about 20 seconds after the steering control is switched to manual, or the control unit 10 determines the switching timing to be infinite. Specifically, if the switching timing is determined to be infinite, acceleration/deceleration control is postponed until the relaxation degree increases.

The control unit 10 then determines at step S160 whether the switching timing of acceleration/deceleration control has arrived. If the switching timing has not arrived, the control unit 10 returns to step S130. In this case, the relaxation degree is recalculated.

If the switching timing has arrived, the control unit 10 calculates at step S210 a reference operation amount including a target steering direction and a target steering amount. The target steering direction and the target steering amount refer to values calculated by the control unit 10 based on the surroundings of the own vehicle or the route to the destination, assuming that the steering control is being continued.

The control unit 10 then obtains at step S220 an input operation amount including an input steering direction and an input steering amount. The input steering direction and the input steering amount refer to a steering direction and a steering amount actually inputted to the steering wheel by the own vehicle driver from among the results detected by the sensor section 22.

The control unit 10 then calculates the difference between the reference operation amount and the input operation amount at step S230. Specifically, the control unit 10 calculates the difference between the target steering direction and the input steering direction, and the difference between the target steering amount and the input steering amount.

The control unit 10 then calculates at step S235 a steering control variable according to the input operation amount. The steering control variable here refers to, for example, an assist control variable outputted by a known power steering device.

The control unit 10 then compares at S240 the absolute value of each difference with a predetermined control threshold. This process determines whether the operation inputted by the driver satisfies predetermined condition.

The control threshold is set to be a positive value. If the absolute value of the difference is less than the control threshold, the control unit 10 proceeds to step S310 which is described below. If the absolute value of the difference is not less than the control threshold, the control unit 10 compares at step S250 the difference with a predetermined limit threshold. The absolute value of the limit threshold is set to be greater than that of the control threshold.

If the difference is not less than the limit threshold, the control unit 10 limits the steering control variable at step S260. That is, the control unit 10 changes the steering control variable set at step S235 to a predetermined upper limit value. As a result, the steering control variable is corrected so that the difference becomes smaller. Then, the control unit 10 proceeds to step S270.

If the difference is less than the limit threshold, the control unit 10 corrects at step S270 the steering control valuable so that the difference becomes smaller. Specifically, the steering control variable is corrected so as to come closer to the target steering amount and the target steering direction, both calculated at step S210. For example, the control unit 10 corrects the steering control variable by multiplying it by a preset constant. If the steering control amount is changed to the upper limit value, the difference is corrected to be even smaller.

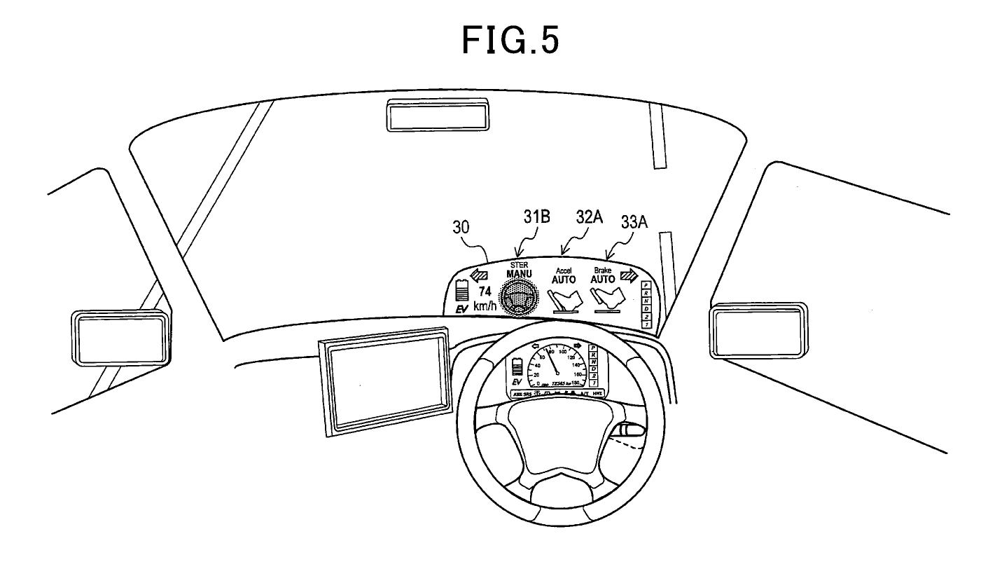

The control unit 10 then notifies at step S280 that the steering control valuable has been changed to the upper limit value, or the steering control variable has been corrected to change the assist control variable. In this case, as shown in FIG. 5, for example, the control unit 10 changes the display mode such as by flashing the manual steering icon 31B, so that the driver can visually recognize the change of the steering control variable. When this process terminates, control goes back to step S120.

The control unit 10 stops acceleration/deceleration control at step S310 and switches operation to manual. Specifically, the control unit 10 stops the output of the accelerator control variable and the brake control variable to the automatic driving actuator 26.

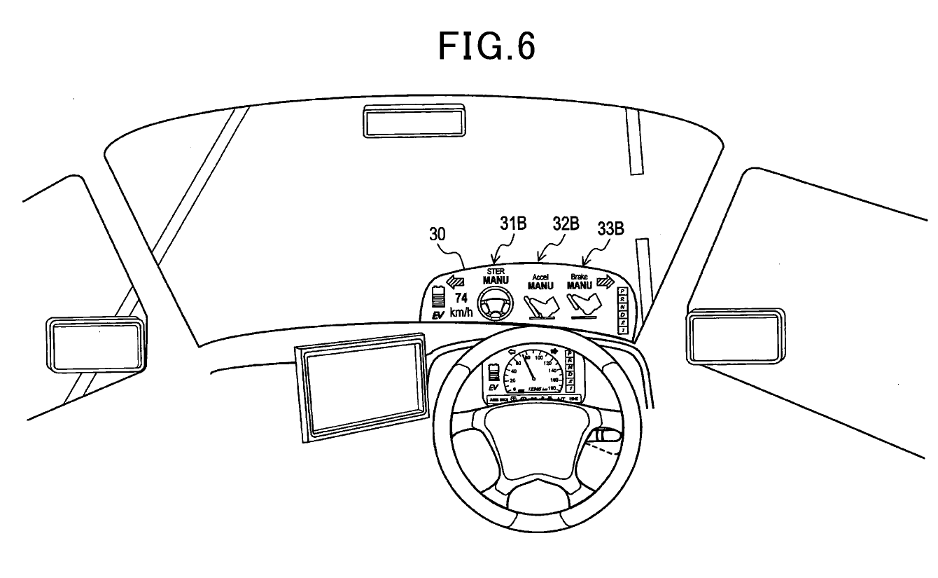

The control unit 10 then notifies the driver at step S320 that acceleration/deceleration control has been switched to manual. For example, as shown in FIG. 6, the control unit 10 displays a manual accelerator icon 32B and a manual braking icon 33B on the headup display 30, instead of the automatic accelerator icon 32A and the automatic braking icon 33A. The control unit 10 also displays the manual steering icon 31B.

The manual accelerator icon 32B and the manual braking icon 33B include patterns representing pedals, and information that the control unit 10 is not actuated, that is, a literal sign

“MANU” indicating pedal operation is manual. The display mode of patterns representing the pedals of the manual accelerator icon 32B and the manual braking icon 33B are different from those of the automatic accelerator icon 32B and the automatic braking icon 33B.

Termination of this processing means the termination of the manual-switching process.

### 1-3. Effects

The first embodiment described above in detail yields the following effects as follows.

(1a) In the vehicle control apparatus 1, the control unit 10 obtains data of surroundings of the own vehicle. According to the data of the surroundings, the control unit 10 conducts vehicle control including acceleration/deceleration control, which represents control related to acceleration/deceleration of the own vehicle, and steering control, which represents control related to steering of the own vehicle. Upon input of a stop command indicating stop of the vehicle control, the control unit 10 stops first control which is either of acceleration/deceleration control and steering control. The control unit 10 then stops second control which is the other of acceleration/deceleration control and steering control, at timing different from the timing to stop the first control.

According to the vehicle control apparatus 1 with such a configuration, acceleration/deceleration control and steering control are stopped at different timing. Thus, the driver only needs to respond to the stop of acceleration/deceleration control and the stop of steering control in turn. Therefore, the driver can drive the own vehicle smoothly.

(1b) The vehicle control apparatus 1 copes with acceleration/deceleration operation which represents acceleration/deceleration of the own vehicle, and the steering operation which represents the steering of the own vehicle. With regard to either of the operations related to the first control, the control unit 10 obtains the input operation amount which corresponds to the operation amount actually inputted by the driver. After the stop of the first control, the control unit 10 then determines whether the input operation amount corresponds to the operation satisfying the predetermined condition. If the operation satisfying the condition is not executed, the control unit 10 inhibits the stop of the second control.

According to the vehicle control apparatus 1 with such a configuration, the automatic driving is partially continued without stopping the second control if the operation does not satisfy the predetermined condition. Therefore, according to the operation status of the driver, the control unit 10 can adjust the timing of stopping the second control to appropriate timing.

(1c) The control unit 10 of the vehicle control apparatus 1 calculates the reference operation amount after the stop of the first control. The reference operation amount refers to the amount that the driver should input with regard to the first control operation, based on the surroundings of the own vehicle. As the above-descried condition, the control unit 10 also determines whether the difference between the reference operation amount and the input operation amount is not less than the predetermined control threshold.

The vehicle control apparatus 1 with such a configuration determines whether an operation satisfying the condition has been carried out, by using the difference between the reference operation amount and the input operation amount. If the driver has performed an operation not expected by the apparatus, the control unit 10 is ensured not to stop the second control. This can secure the safety of the own vehicle.

(1d) The control unit 10 of the vehicle control apparatus 1 calculates the operation control variable which represents the control variable of the operation related to the first control, according to the input operation amount. If the difference between the reference operation amount and the input operation amount is not less than the predetermined operation threshold, the control unit 10 changes the operation control variable to the control variable that is calculated when the difference is smaller.

According to the vehicle control apparatus 1 with such a configuration, if the difference between the reference operation amount and the input operation amount is not less than a second threshold set in advance, the input operation amount is changed so that the difference becomes smaller. This is why the vehicle is prevented from excessively responding to the driver's possible excessive operation. Therefore, the apparatus can improve safety when changing the driving mode from automatic to manual.

(1e) The control unit 10 of the vehicle control apparatus 1 changes the operation control variable to a limit control variable which is predetermined to reduce the difference between the reference operation amount and the input operation amount.

According to the vehicle control apparatus 1 with such a configuration, the operation control variable can be set to the limit control variable which is an upper limit value or a lower limit value. Therefore, with the simple configuration, the apparatus can improve safety when changing the driving mode from automatic to manual.

(1f) If the operation control variable has changed, the control unit 10 of the vehicle control apparatus 1 notifies the own vehicle driver of the information that the operation control variable has changed.

According to the vehicle control apparatus 1 with such a configuration, if the operation control variable is changed, the apparatus notifies the driver of the own vehicle accordingly. The notification can alleviate the unease felt of the driver, and can increase the attention of the driver.

(1g) The control unit 10 of the vehicle control apparatus 1 notifies the driver of the own vehicle about the control status indicating whether the first and the second controls are being executed or being stopped.

The vehicle control apparatus 1 can notify the driver whether the acceleration/deceleration control and the steering control are being executed.

(1h) The control unit 10 of the vehicle control apparatus 1 obtains the relaxation degree of the driver's driving operation of the own vehicle after the stop of the first control. If the relaxation degree is less than a predetermined reference value, a second stopping section postpones the operation of stopping the second control.

The vehicle control apparatus 1 with such a configuration delays the timing of stopping the second control when the relaxation degree is small, that is, the driver's driving load is large. Consequently, the apparatus can provide relaxation to the driver's driving operation.

### 2. Second Embodiment

### 2-1. Differences from the First Embodiment

Since the basic configuration of the second embodiment is the same as the first embodiment, the following description will be focused on the differences between these embodiments. Also, since like reference signs herein refer to like components of the first embodiment, the preceding description should be referred to for such components.

In the first embodiment, the control unit 10 determines whether various conditions are satisfied, from the moment the authority of the steering related control is transferred to the driver until the moment the authority of acceleration/deceleration related control is transferred to the driver. If the various conditions are satisfied, authority of controlling acceleration/deceleration control is transferred to the driver. The second embodiment differs from the first embodiment in that whether the various condition is satisfied is determined before transferring authority of the steering related control to the driver. The condition for transferring authority and the timing of notification are also different from the first embodiment.

### 2-2. Processing

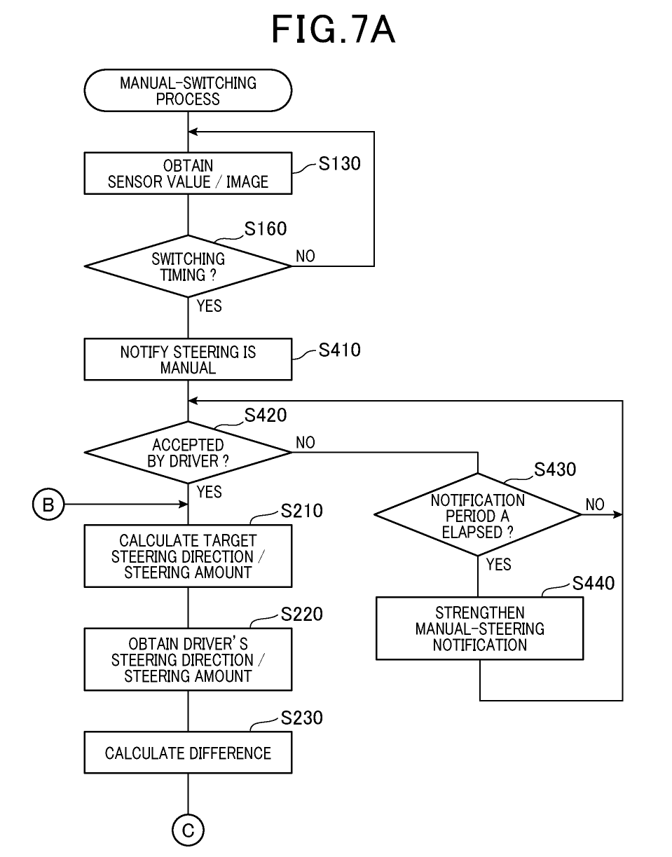

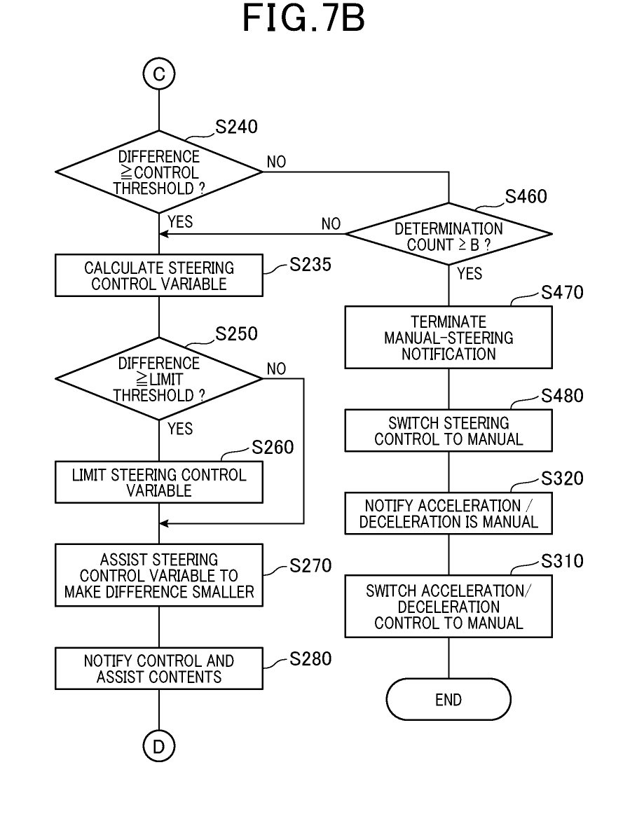

With reference to the flowchart shown in FIGS. 7A and 7B, description will be given of a manual-switching process of the second embodiment executed by the control unit 10, instead of the manual-switching process of the first embodiment. The manual-switching process of the second embodiment is started, for example, when the automatic driving is executed.

In the manual-switching process of the second embodiment, the control unit 10 first executes step S130. In this case, the control unit 10 obtains information such as the location where the automatic driving is to be ended, and the location of the own vehicle.

Then, the control unit 10 determines at step S160 whether the switching timing of acceleration/deceleration control has arrived. In this process, as described above, the timing to change steering control or acceleration/deceleration control from automatic to manual according to the relaxation degree can be set as the switching timing. However, in this embodiment, if the location where the automatic driving is to be ended substantially agrees with the location of the own vehicle, the control unit 10 takes this timing to be the switching timing.

If the switching timing has not arrived, control returns to step S130. If the switching timing has arrived, the stop command is taken to have been inputted, and thus the following process is executed. First, control conducts a manual-steering notification at step S410.

The mode of notification herein may be similar to that of step S120. At step S120, the control unit 10 notifies the driver that steering control has switched to manual. However, a notification at step S410 differs from that of step S120 in that, before steering control has switched to manual, the control unit 10 notifies the driver that steering control is about to be switched to manual.

Subsequently, at step S420, the control unit 10 determines whether a predetermined stop condition has been established. As the stop condition, the control unit 10 determines whether the driver of the own vehicle has accepted the stop command. The step S240 also corresponds to the determination of the stop condition.

Examples of cases where the driver has accepted the stop command include cases where the predetermined button operation of the driver has been detected, where a sensor installed in a steering wheel or the like has detected that the driver is touching or holding the steering wheel, where a sensor such as a seating sensor has detected a change of state from a state where the driver's leg is raised from the seat to a state where the leg is lowered to place his/her foot near the pedals, and where a sensor such as a camera has detected that the direction of the driver's face is facing in the traveling direction of the own vehicle.

If no stop condition has been established, such as when the driver has not accepted the stop command, the control unit 10 determines, at step S430, whether a predetermined notification period A has elapsed. A notification period A refers to an elapsed time after the notification has started at step S410.

The notification period A is a period of time required for the driver to prepare for manual driving after start of the notification that steering control is about to be switched to manual. The notification period A is set, for example, to about three to five seconds.

If the notification period A has not elapsed, control returns to Step S420. If the notification period A has elapsed, the control unit 10 changes the manual-steering notification to a stronger notification at Step S440. The stronger notification refers to a notification more easily noticed by the driver. People tend to more easily notice red color than other colors, more easily notice a flashing light than a light not flashing, and more easily notice moving objects than stationary objects.

People also tend to easily notice activities that are both visible and audible, rather than activities that are only visible. In this regard, in the present step, stronger notification is given by changing the notification mode to one more easily noticed by people. After Step S440, control returns to Step S240.

When steps S420 and S430 are repeated, operation for stopping steering control and acceleration/deceleration control is inhibited, until the stop condition is established. If the stop condition has been established, such as when the driver has accepted the stop command at step S420, the above-descried steps S210 to S240 are executed.

At step S240, the control unit 10 determines whether another stop condition is established. At this step, the control unit 10 compares the difference between the target steering direction and the input steering direction with a predetermined control threshold. At the same time, the control unit also compares the difference between the target steering amount and the input steering amount with another predetermined control threshold. If these differences are less than the respective control thresholds, it is determined that the other stop condition has been established.

If each difference is not less than the control threshold, it is considered that the other stop condition has not been established, thereby executing the above-described steps S235 to S280 and then returning to step S210. If each difference is less than the control threshold, it is considered that the other stop condition has been established, thereby the control unit 10 counts the number of times the other stop condition has been established at step S460. Then, the control unit 10 compares the count with a predetermined determination count B.

The determination count B is provided to reduce or prevent malfunction which may be caused when stop condition has been established unintentionally by the influence of noise or the like. Therefore, the determination count B is set to a value of 2 or more, and is set to a value, for example, of about 2 to 5.

If the count (number of times) for the other stop condition to be established is less than the determination count B, control proceeds to the above step S235. If the count for the other stop condition to be established is not less than the determination count B, the control unit 10 terminates, at step S470, the manual-steering notification which has been continued since steps S410 and S440.

Then, at step S480, processing for stopping the steering control and switching the operation to manual is executed similarly to step S110. Subsequently, the control unit 10 executes steps S320 and S310 in this order, and terminates the manual-switching process.

### 2-3. Advantageous Effects

The second embodiment described above in detail yields not only the effects (1a) of the above-described first embodiment, but also the following effects.

(2a) The control unit 10 of the vehicle control apparatus 2 is configured to repeatedly determine whether the predetermined stop condition has been established when the stop command is inputted. Also, the control unit 10 is configured to inhibit at least one of the operation to stop the first control and the operation to stop the second control, until the stop condition is established.

According to the vehicle control apparatus 2 with such a configuration, until the stop condition is established, at least one of the first and the second controls is ensured not to be stopped. Thus, the apparatus can transfer the first or the second control to the driver's operation more safely.

(2b) The control unit 10 of the vehicle control apparatus 2 repeatedly determines whether the driver of the own vehicle has accepted the stop command. Until the moment the control unit determines the driver of the own vehicle has accepted the stop command, the operation to stop the first control or the operation to stop the second control is inhibited.

The vehicle control apparatus 2 with such a configuration is ensured not to stop at least one of the first and the second controls until the driver of the own vehicle is ready to accept the stop command. Thus, the apparatus can transfer the first or the second control to the driver's operation more safely.

(2c) When the stop command is inputted, the control unit 10 of the vehicle control apparatus 2 notifies the driver of information that the first control or the second control is to be stopped. The apparatus then determines whether the stop condition has been established within the predetermined notification period from the start of this notification. Then, if the stop condition has not been established within the notification period, the notification is changed to a stronger one.

According to the vehicle control apparatus 2 with such a configuration, if the stop condition has not been established within the notification period, the apparatus changes the notification to a stronger one. Thus, the apparatus can prompt the driver to establish the stop condition.

(2d) The control unit 10 of the vehicle control apparatus 2 counts the number of times the stop condition has established, and determines whether the count is not less than the predetermined determination count. Then, until the count reaches not less than the determination count after the establishment of the stop condition, the control unit inhibits the operation of stopping the first control or the operation of stopping the second control.

The vehicle control apparatus 2 with such a configuration inhibits the operation of stopping the first control or the operation of stopping the second control until the counts of established stop condition reaches not less than the determination count. Thus, the apparatus can reduce or prevent the malfunction which may be caused when stop condition has been established unintentionally by an influence of noise or the like.

### 3. Other Embodiments

Embodiments to carry out the present disclosure have been described so far, however, the present disclosure is not limited to the above embodiments, but may be implemented in various modes.

(3a) The above embodiments switch the driving mode to manual in the order of steering control and acceleration/deceleration control, but configuration is not limited to this. For example, in one mode, the vehicle control apparatus may switch the driving mode to manual in the order of acceleration/deceleration control and steering control. The vehicle control apparatus may also include other controls. The order of switching the driving mode to manual may be set with the inclusion of these other controls.

(3b) While the above embodiments describe the manual-switching process of the first embodiment and that of the second embodiment separately, the manual-switching process of the first embodiment and that of the second embodiment may be optionally combined.

Specifically, before switching the steering control to manual, either of the manual-switching processes shown in FIGS. 2A and 2B may be executed optionally. Also, before switching acceleration/deceleration control to manual, the optional processing of either the manual-switching processes shown in FIGS. 7A or 7B may be executed.

(3c) The above-described embodiments have not assumed an erroneous operation of the driver. However, a known configuration may be used for determining whether the driver has erroneously operated the vehicle, and if the driver has actually operated the vehicle erroneously, the operation may be ensured to be cancelled. For example, there may be a case where the driver mistakenly presses the pedals, that is, a case where the driver may strongly press the accelerator pedal, even though the vehicle control apparatus 1 or 2 is determining that the vehicle should decelerate. In such a case, the vehicle control apparatus 1 or 2 can disable the driver's operation to step on the accelerator pedal.

(3d) The functions of one component in the above embodiment may be distributed to a plurality of components, or the functions of a plurality of components may be integrated into one component. Part of the configuration of the above embodiment may be omitted. At least part of the configuration of the above embodiment may be added to or replaced by the configuration of the above other embodiments. The embodiments of the present disclosure include any mode encompassed by the technical idea which is specified only by the wording of the disclosure.

(3e) In addition to the above-described vehicle control apparatus 1, the present disclosure may be accomplished in various forms such as a system comprising the vehicle control apparatus 1 as a component, a program for causing a computer to function as the vehicle control apparatus 1, a non-transitory tangible recording medium, such as a semiconductor memory storing the program, and a vehicle control method.

### 4. Correspondence Between the Configuration of the Embodiments and the Configuration of the Present Disclosure

The control unit 10 of the above embodiments corresponds to the vehicle control apparatus or the vehicle control unit of the present disclosure. Among the processing that the control unit 10 of the above embodiments executes, step S110 corresponds to the first stopping section of the present disclosure, and steps S120 and S320 correspond to the execution notifying section of the present disclosure.

Step S140 of the above embodiments corresponds to the relaxation degree obtaining section of the present disclosure, and the step S150 and S160 of the embodiment correspond to the relaxation postponement section of the present disclosure. Step S210 of the above embodiments corresponds to the reference calculation section, and step S220 of the embodiment corresponds to the input obtaining section of the present disclosure.

Steps S230 and S240 of the above embodiments correspond to the condition determination section of the present disclosure, and step S235 of the embodiment corresponds to the control variable calculation section of the present disclosure. Step 240 of the above embodiments correspond to the condition inhibition section, and steps S260 and S270 correspond to the control amount changing section of the present disclosure.

Step 280 of the above embodiments corresponds to the change notification section of the present disclosure, and the step S310 of the embodiments corresponds to the second stopping section of the present disclosure. Steps S240, S420, and S460 of the above embodiments correspond to the stop determination section and the stop inhibition section of the present disclosure, and step S410 of the embodiments corresponds to the stopping notification section of the present disclosure.

Step S430 of the above embodiments corresponds to the establishment determination section of the present disclosure, and step S440 of the embodiments corresponds to the notification change section of the present disclosure. Step S460 of the above embodiments corresponds to the count determination section of the present disclosure.

1. A vehicle control apparatus configured to control movement of an own vehicle, comprising:
a vehicle control unit configured to obtain data of surroundings of the own vehicle, and execute vehicle control including acceleration/deceleration control representing control for acceleration/deceleration of the own vehicle and steering control representing control for steering of the own vehicle, according to the data of the surroundings;
a first stop section configured to stop a first control representing either of the acceleration/deceleration control and the steering control, upon input of a stop command representing stop of the vehicle control;
a second stop section configured to stop a second control representing the other of the acceleration/deceleration control and the steering control, at timing different from timing to stop the first control;
a stop determination section configured to repeatedly determine whether a predetermined stop condition is established, upon input of the stop command;
a stop inhibition section configured to inhibit at least one of an operation under which the first stop section stops the first control or an operation under which the second stop section stops the second control, until the stop condition is established;
an input obtaining section configured to obtain an input operation amount representing an operation amount actually inputted by the driver regarding the first control which is either of an acceleration/deceleration operation representing acceleration/deceleration of the own vehicle, and an steering operation representing steering of the own vehicle;
a control variable calculation section configured to calculate an operation control variable representing a control variable of an operation related to the first control, according to the input operation amount and
a control variable changing section configured to change the operation control variable to a corrected control variable which is calculated if a difference between the reference operation amount and the input operation amount is not less than a predetermined operation threshold, and if the difference is smaller.

2. (canceled)

3. The vehicle control apparatus according to claim 1, wherein:
the stop determination section is configured to repeatedly determine whether an own vehicle driver has accepted the stop command; and
the stop inhibition section is configured to inhibit the operation under which the first stop section stops the first control, or the operation under which the second stop section stops the second control until, the own vehicle driver is determined to have accepted the stop command.

4. The vehicle control apparatus according to claim 1, further comprising:
a stop notification section configured to notify the own vehicle driver of information that the first control or the second control is to be stopped;
an establishment determination section configured to determine whether the stop condition has been established within a predetermined notification period after the start of this notification; and
a notification change section configured to change the notification to a stronger notification when the stop condition has not been established within the notification period.

5. The vehicle control apparatus according to any one of claim 1, wherein:
the apparatus further comprises a count determination section configured to count the number of times the stop condition has established, and determine whether the number of times is not less than a predetermined count; and
the stop inhibition section is configured to inhibit either the operation under which the first stop section stops the first control or the operation under which the second stop section stops the second control until the number of times reaches not less than the predetermined count after the establishment of the stop condition.

6. The vehicle control apparatus according to any one of claim 1, further comprising:
a condition determination section configured to determine whether the input operation amount corresponds to an operation satisfying a predetermined condition, after the stop of the first control; and
a condition inhibition section configured to inhibit the operation under which the second stop section stops the second control, when no operation to satisfy the condition is executed.

7. The vehicle control apparatus according to claim 6, wherein:
the apparatus further comprises a reference calculation section configured to calculate an operation amount that the driver should input as a reference operation amount with regard to the first control operation, after the stop of the first control, and according to surroundings of the own vehicle; and
the condition determination section is configured to determine, as the condition, whether a difference between the reference operation amount and the input operation amount is not less than a predetermined control threshold.

8. (canceled)

9. The vehicle control apparatus according to claim 1, wherein:
the control variable changing section is configured to change the operation control variable to a limit control variable predetermined to reduce the difference.

10. The vehicle control apparatus according to claim 1, further comprising:
a change notification section configured to notify the own vehicle driver about information that the operation control variable is changed, if the operation control variable is changed.

11. The vehicle control apparatus according to claim 1, further comprising:
an execution notifying section configured to notify the own vehicle driver of the control status indicating whether the first control and the second control are currently executed or currently stopped.

12. The vehicle control apparatus according to claim 1, further comprising:
a relaxation degree obtaining section configured to obtain a relaxation degree of the own vehicle driver for driving operation after the stop of the first control; and
a relaxation postponement section configured to postpone an operation under which the second stopping section stops the second control, if the relaxation degree is less than a predetermined reference value.
